(19) United States
(12) Patent Application Publication
(10) Pub. No.: US 2005/0213219 A1
(43) Pub. Date: Sep. 29, 2005

(54) Means of compensation to increase the contrast ratio of LCoS based video projection systems

(76) Inventor: Arthur Berman, San Jose, CA (US)

Correspondence Address: Reed Smith LLP, P.O. Box 7936, San Francisco, CA, 94120-7936, US

(21) Appl. No.: 10/812,528

(22) Filed: Mar. 29, 2004

(51) Int. Cl. G02B 27/14

(52) U.S. Cl. 359/634

(57) ABSTRACT

An arrangement of optical components and orientation thereof that performs both skew ray compensation and reduction of residual retardation in LCoS based display devices. A principle axis of a quater waveplate oriented is aligned parallel to reference axis, and a microdisplay device is coupled to the quarter waveplate and oriented at an angle θo such that an optical “axis” of the microdisplay is optimally oriented for residual retardation compensation with respect to the linearly polarized light input to the microdisplay from the quarter waveplate when the reference axis is parallel to an axis of linear polarization of light incident to the quarter waveplate. A quarter waveplate and a half wavplate are oriented at ½ theta and a microdsiplay is oriented at theta. A prism assembly contructed using microdsiplay packages that simultaneously perform skew ray and residual retardation compensation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of Invention

The invention is related to optical devices and more particularly related to LCoS based projection systems. The invention is yet further related to increasing a contrast ratio in an LCoS based display.

2. Discussion of Background

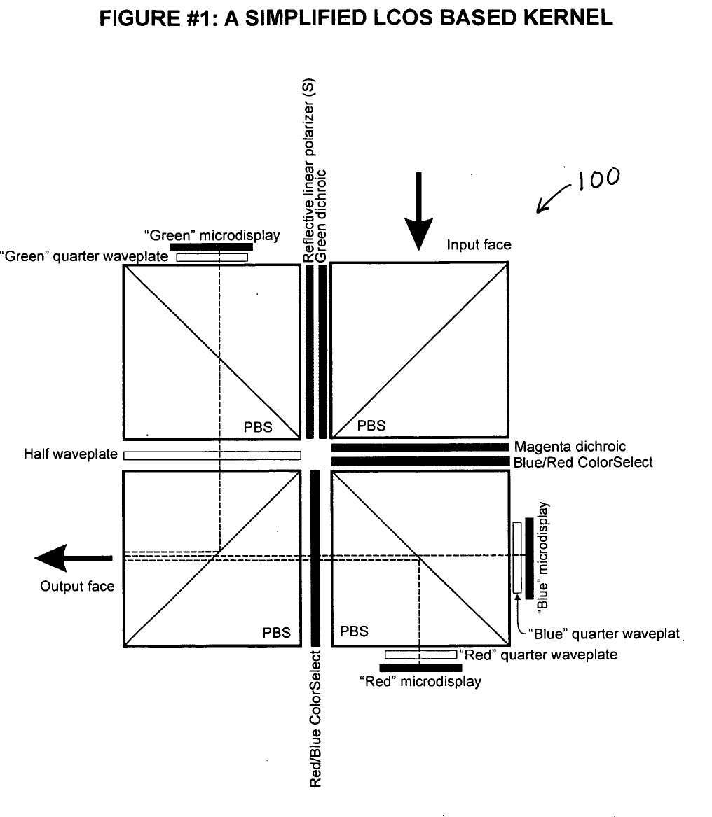

The projection mechanism within a microdisplay based video projector is called a light engine. The optical heart of the light engine is called the kernel. A generic kernel is composed of a prism assembly and three LCoS microdisplays. An example of a specific kernel 100, a quad type kernel of particular interest to LightMaster Systems, is illustrated in FIG. 1. Note that the pixel arrays contained within each of the three microdisplays must be mutually aligned to a high degree of accuracy.

Part of the challenge in designing a light engine is to produce an image with the highest possible contrast ratio. The best and usual way by which this is accomplished is to produce the blackest possible dark state. Two of the procedures known to blacken the dark state are discussed below.

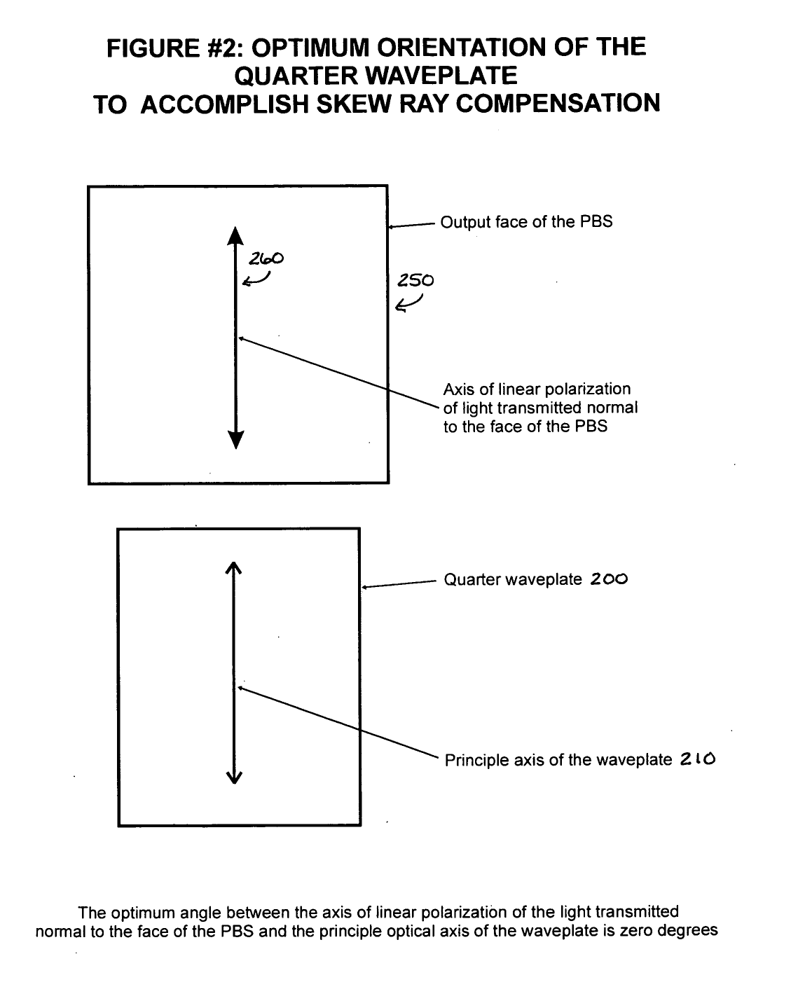

The first procedure is called skew ray compensation. The purpose of this procedure is to improve the linear polarization of off-axis light rays transmitted by the Polarizing Beam Splitting (PBS) cubes. The method is to place a quarter waveplate in optical series with the output of the PBS such that a principle axis of the waveplate is parallel to the axis of linear polarization of light rays transmitted normal to the face of the PBS. A configuration for skew ray compensation is illustrated in FIG. 2.

Although not strictly required, the optimum compensation will occur when the wavelength at which the value of the retarder is exactly a quarter wave matches the center of the spectrum transmitted by the PBS.

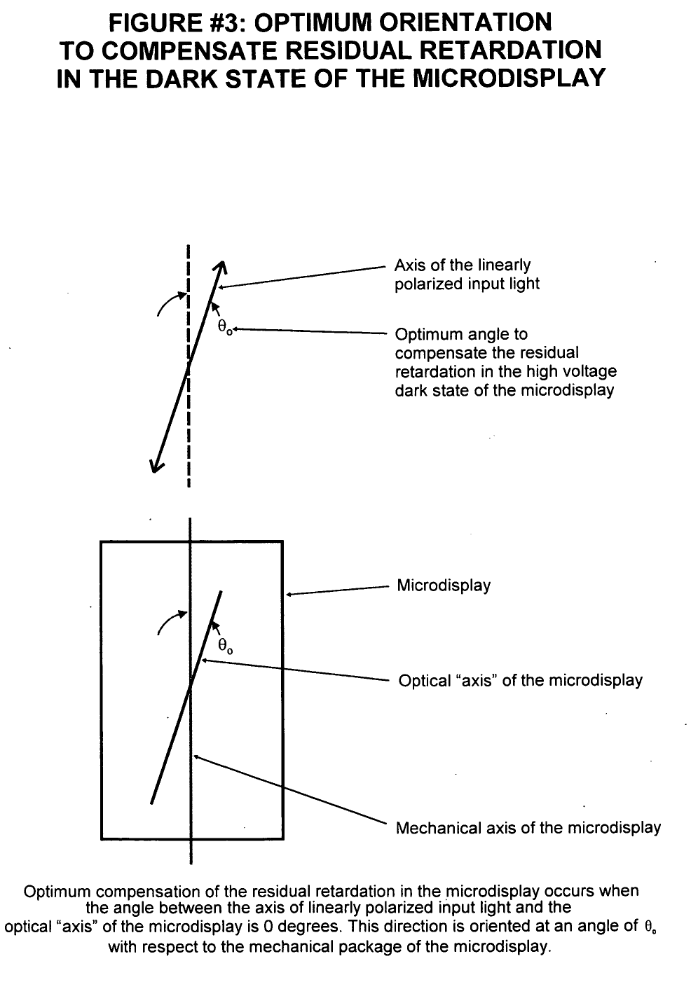

The second procedure is to compensate the residual retardation found in the high voltage, dark state of the microdisplay. A configuration for residual retardation compensation is illustrated in FIG. 3. The method provides that the linearly polarized light input to the microdisplay be oriented parallel to the optical “axis” of the microdisplay. This “axis” is typically at a small angle with respect to the mechanical “package” of the microdisplay. The optimum angle is determined by first applying the highest available voltage to the microdisplay. (This produces the lowest possible value of residual retardation.) Placed in optical series with the face of the PBS, the microdisplay is then rotated about its Z-axis until the intensity of the reflected light is minimized (as observed at the output of the prism assembly).

Note that the residual retardation compensation method described above specifically applies to LCoS microdisplays that utilize the so-called normally bright, 45° TN, mixed mode electro optic effect. Variations of the method may be needed to compensate the residual retardation in LCoS microdisplays that utilize other electro optic effects.

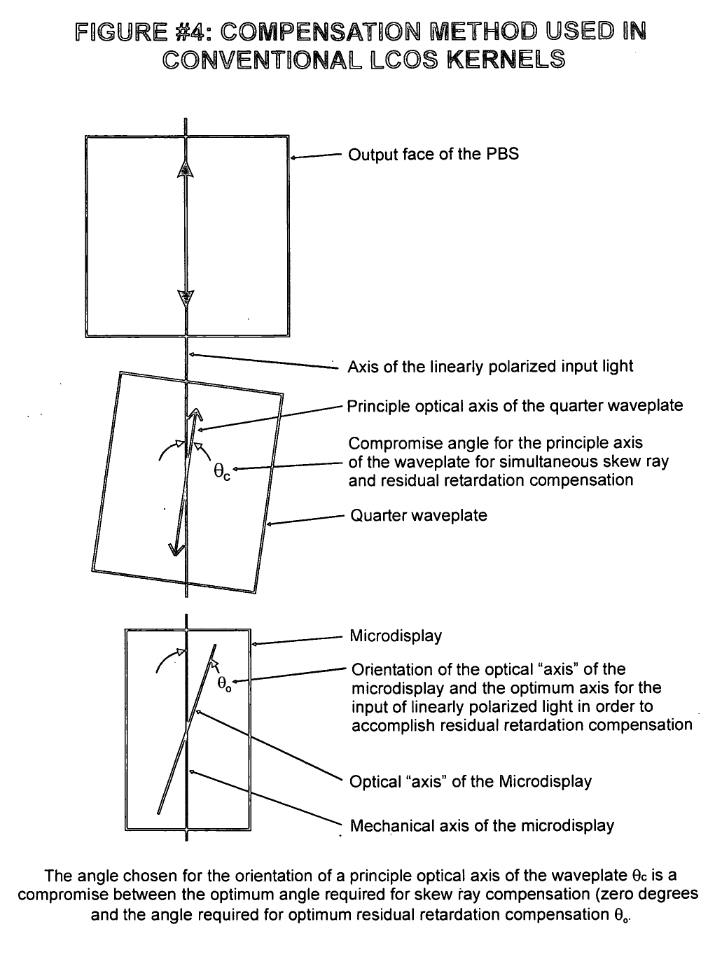

Clearly, the axis of the skew ray compensated linearly polarized light output by the PBS is not oriented properly for optimum residual retardation compensation. A way that these conflicting compensation requirements are accommodated in conventional kernel/light engine configurations is illustrated in FIG. 4.

As shown, the principle axis of the quarter waveplate is mechanically rotated to a compromise angle θ_{c}. It is intermediate between that required for optimum skew ray compensation (0 degrees) and that required for the input of linearly polarized light (θₒ) to optimally accomplish residual retardation compensation in the microdisplay. The exact orientation of the principle axis of the quarter waveplate is determined by minimizing the light reflected from the fully energized microdisplay as observed at the output of the prism assembly. Although effective, this compromise configuration accomplishes neither full skew ray nor residual retardation compensation.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

### SUMMARY OF THE INVENTION

The present inventors have realized a method and devices for simultaneous skew ray and residual retardation compensation. In one embodiment, the present invention provides a microdisplay package, comprising a microdisplay having an optical axis, and a quarter waveplate coupled to the microdisplay. The quarter waveplate may be cut such that a principle axis of the quarter waveplate is parallel to the optical axis of the microdisplay.

In another embodiment, the present invention provides a microdisplay package, comprising, a quater waveplate oriented such that a principle axis of the quater waveplate is aligned parallel to reference axis, and a microdisplay device coupled to the quarter waveplate and oriented at an angle θₒ such that an optical “axis” of the microdisplay is optimally oriented for residual retardation compensation with respect to the linearly polarized light input to the microdisplay from the quarter waveplate when the reference axis is parallel to an axis of linear polarization of light incident to the quarter waveplate.

In another embodiment the present invention provides a microdisplay package, comprising, A quater waveplate having a principle axis parallel of a reference axis, a half waveplate having a principle optical axis oriented at an angle of (½)θₒ with respect to the reference axis, and a microdisplay having an optical axis oriented at an angle of θₒ with respect to the reference axis.

The present invention includes a method of skew ray and residual retardation compensation in a microdisplay based device, comprising the steps of, operating on light channel directed to a microdisplay with a quater waveplate oriented such that a principle axis of the quater waveplate is aligned parallel to an axis of linear polarization of the light channel incident upon the quarter waveplate, and modulating the light channel after the quarter waveplate with a microdisplay oriented at an angle θₒ such that an optical “axis” of the microdisplay is optimally oriented for residual retardation compensation with respect to the linearly polarized light input to the microdisplay from the quarter waveplate.

The present invetion is also a method of aligning a quarterwaveplate, a half waveplate, and a microdisplay to achieve simulatneaous skew ray and residual retardation compensation, and prism assemblies incorporating the same.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a drawing of a simplified LCoS based kernel;

FIG. 2 is a drawing of an orientation of the quarter waveplate to accomplish skew ray compensation;

FIG. 3 is a drawing of an orientation of a microdisplay to compensate residual retardation in the dark state of the microdisplay;

FIG. 4 is a drawing of a representation of a compensation method used in conventional LCoS kernels;

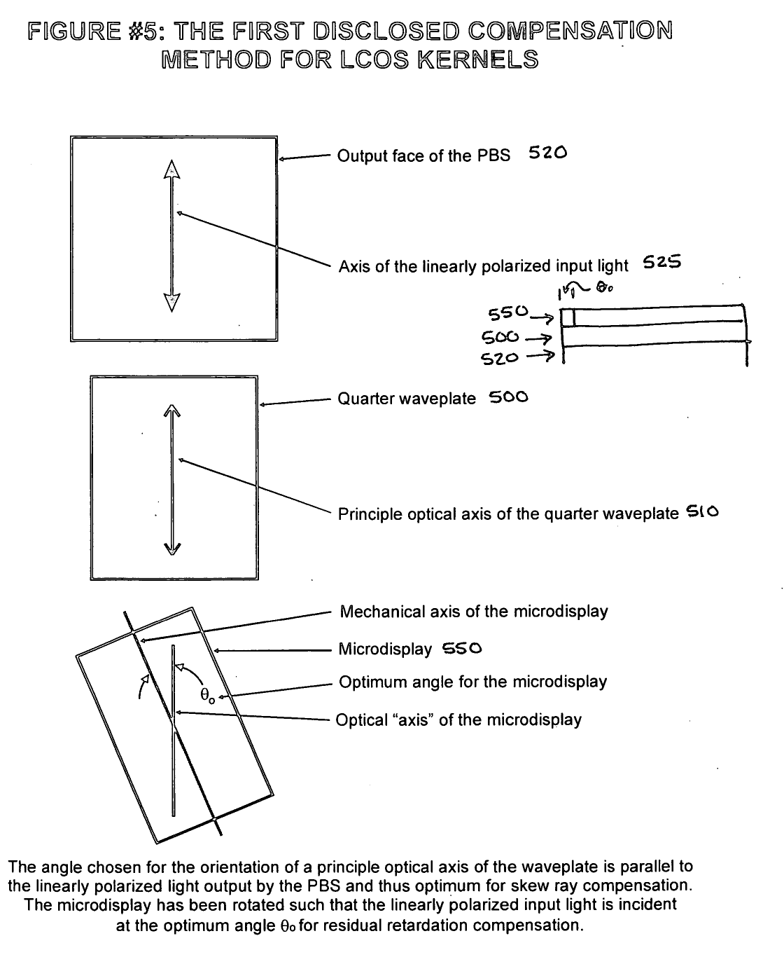

FIG. 5 is a drawing of a representation of a compensation method for LCoS kernels according to an embodiment of the present invention;

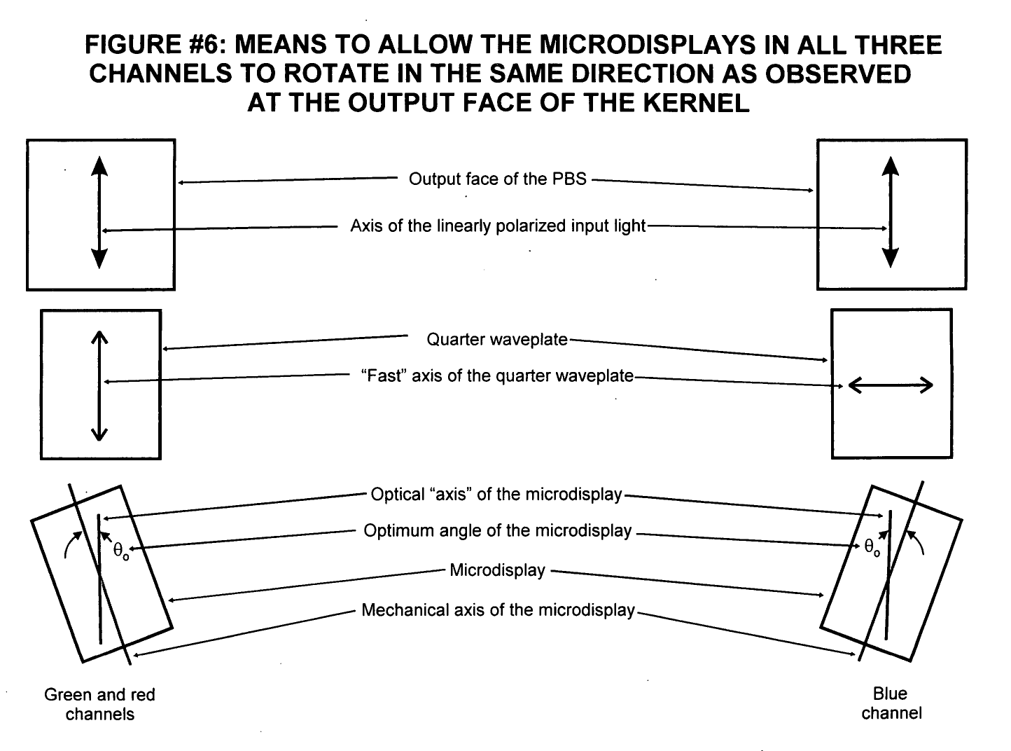

FIG. 6 is a drawing of a representation of a means to allow the microdisplays in all three channels to rotate in the same direction as observed at the output face of the kernel according to an embodiment of the present invention;

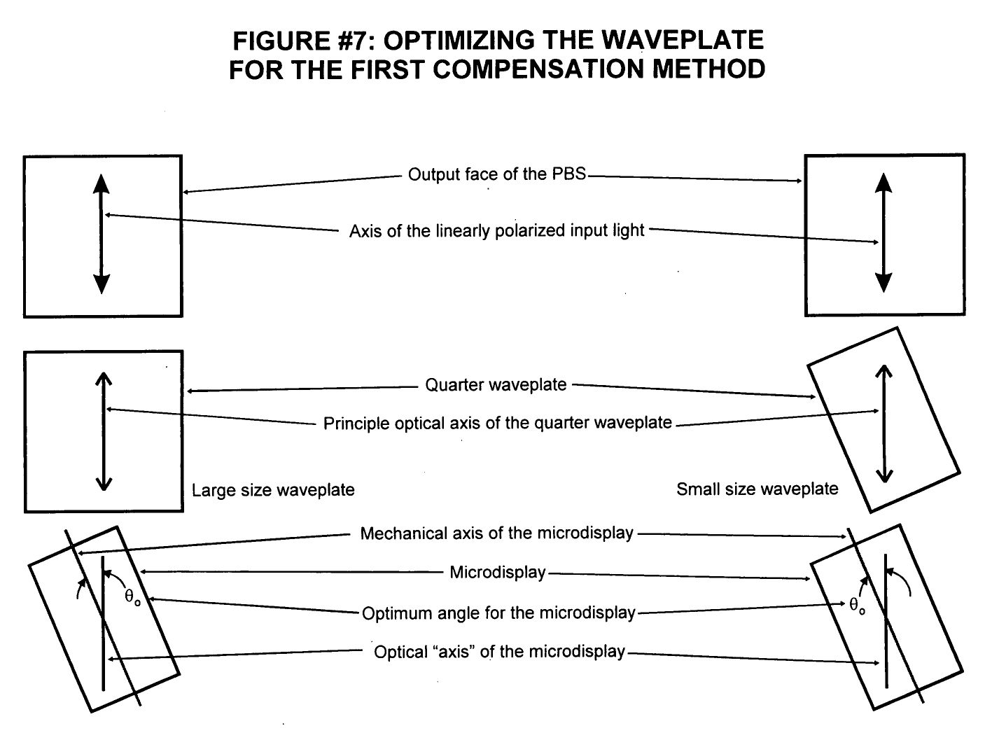

FIG. 7 is a drawing of a representation of an optimizing waveplate according to an embodiment of the present invention;

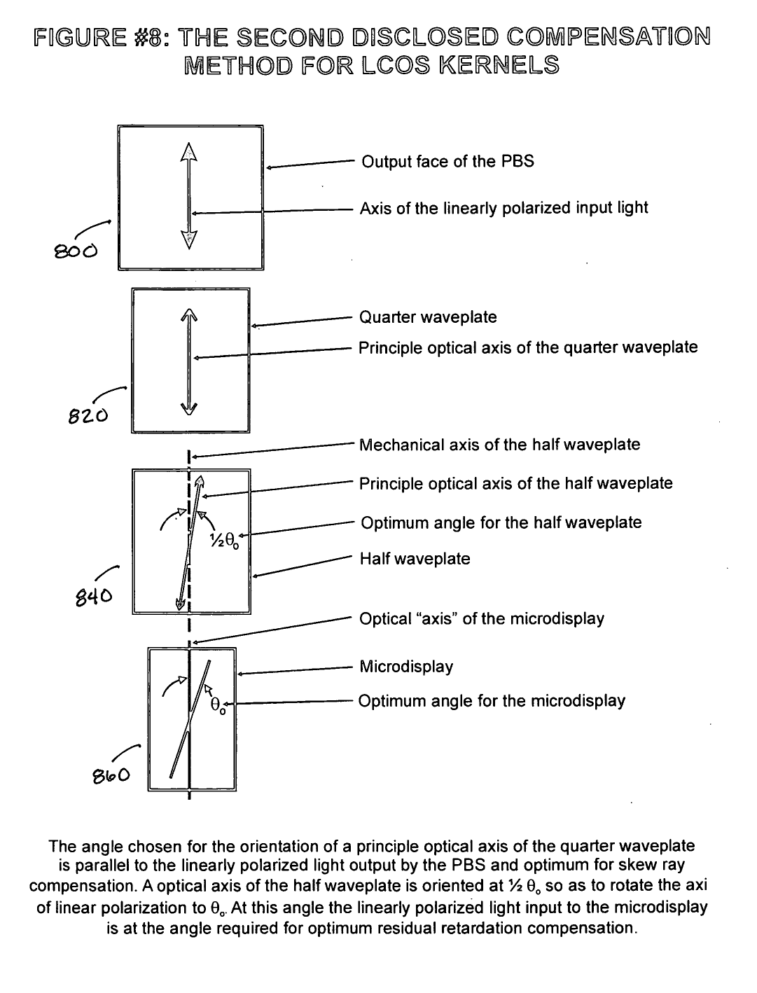

FIG. 8 is a drawing of a representation of another compensation method for LCoS kernels according to an embodiment of the present invention;

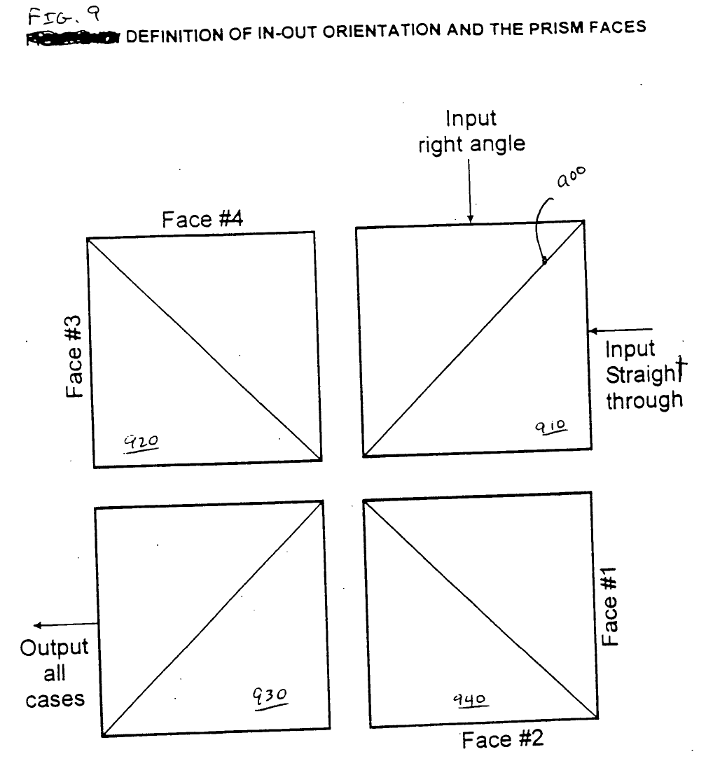

FIG. 9 is a drawing illustrating nomenclature describing a quad style prism; and

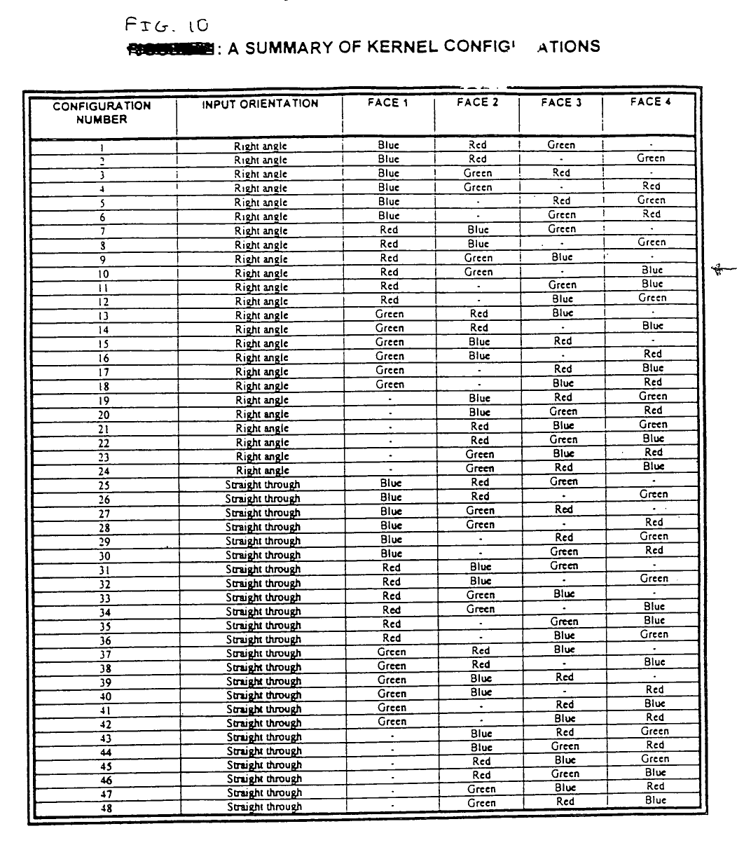

FIG. 10 is a chart illustrating several example kernel configurations to which one or more aspects of the present invention may be applied.

### DESCRIPTION OF THE PREFERRED EMBODIMENTS

The present inventor has realized the need to improve the blackness of the dark state of the video image projected by an LCoS based light engine. The present invention simultaneously accomplishes skew ray and residual retardation compensation.

In one embodiment, the present invention increases the contrast ratio of LCoS microdisplay based video projectors. The improvement is accomplished by “blackening” the dark state of the image. The means utilizes waveplate(s) to optimally and simultaneously perform:
Skew ray compensation. To perfect the linear polarization of the light output by the polarized beam splitters that are a part of the prism assembly.
Residual retardation compensation. Applied to the high voltage dark state of the LCoS microdisplay to minimize residual retardation.

Referring again to the drawings, wherein like reference numerals designate identical or corresponding parts, and more particularly to FIG. 5 thereof, there is illustrated an embodiment of the present invention. As shown, a principle axis 510 of the quarter waveplate 500 is aligned parallel to the axis of linear polarization of light rays output normal to the face of the PBS (and input to the quarter waveplate 500) 525. This is the optimum angle for skew ray compensation. The microdisplay 500 is rotated by an angle θₒ such that its optical “axis” is optimally oriented for residual retardation compensation with respect to the linearly polarized light input to the microdisplay 550 from the quarter waveplate 500.

As a practical matter, the optimum angle θₒ for the blue, green and red microdisplays are likely to be at least slightly different. In a real kernel application a reasonable way to accommodate this difference is to optimally align the green microdisplay since the green content of the image is visually dominant. The orientations of the blue and red microdisplays are adjusted (e.g., rotated) to match that of the green. Although the blue and the red are not fully optimized they will, none-the-less, produce a good dark state, certainly one blacker than if not rotated at all.

A further matter of real practical importance to the application of this compensation technology is that, in the quad type prism illustrated in FIG. 1, the 3 microdisplays are viewed through the output face of the prism assembly under slightly different conditions. That is, the green and red microdisplays are viewed after a single reflection while the blue microdisplay is viewed directly. The consequence of this is that, viewed at the output face, a clockwise rotation applied to the 3 microdisplays is observed as a counterclockwise rotation of the green and blue microdisplays and a clockwise rotation of the red microdisplay. The reason that this is important is that, if the green microdisplay is rotated counterclockwise by θₒ to align its optical “axis” with the input linearly polarized light, then the blue and red microdisplays must also rotate counterclockwise (as observed at the output face) so that their pixel arrays coincide. This is fine for the red microdisplay since it is also viewed after one reflection. When rotated counterclockwise by θₒ, the optical “axis” of the red microdisplay will also be oriented parallel to the input linearly polarized light. Unfortunately, since the blue microdisplay is viewed directly, it is necessary that it rotate clockwise for the pixel array to align with the green and the red microdisplays. By doing so the optical “axis” of the red microdisplay is oriented at an angle of 2θₒ with respect to the input linearly polarized light. Rather than blackening the dark state of the blue microdisplay, such an orientation will completely destroy the contrast ratio.

A solution to this problem is disclosed in FIG. 6. In the blue channel, the orientation of the principle axis of the quarter waveplate is rotated by 90° with respect to the corresponding principle axis of the waveplates in the green and red channels. With the blue quarter waveplate in this orientation, a clockwise rotation of the blue microdisplay to the desired angle θₒ now blackens the dark state of the blue channel in a manner similar to that produced in the green and red channels.

Furthermore, as noted above, FIG. 1 represents an example kernel configuration that has an arrangement of optical components in which the invention may be applied. Many different arrangements of optical components may be utilized along with the techniques of the invention described herein to produce functionally equivalent kernels. For example, FIG. 9 is a diagram illustrating a naming convention for faces of a kernel, and FIG. 10 is a tabular listing of kernel configurations that are also applicable to the present invention and are described using the naming conventions established in FIG. 9. The various configurations utilize different arrangements of dichroics, wavelength specific retarders (e.g., color selects), and polarizers as appropriate for the particular kernel configuration, and such arrangements which will be apparent to those of ordinary skill in the art after review of the present disclosure.

More specifically, the kernel 100 matches the #2 kernel configuration of FIG. 10 (a right angle input and the microdisplays mounted on faces according to kernel configuration #2). When applying the invention to a kernel matching configuration #2, the quarter waveplates and microdisplays are oriented as described above (a principle axis of skew ray quarter waveplates in the green and blue channels are parallel to the axis of linearly polarized input light, and perpendicular in the blue channel; and the blue microdisplay is counter rotated compared to the green and red microdisplays).

In other configurations, adjustments need to be made as to which quarter waveplates are set parallel or perpendicular to the axis of linearly polarized input light and which direction the microdisplays are rotated. The end result of the quarter waveplate and microdisplay orientations operating to increase the contrast ratio of an image passing through the output. For example, in configuration #10, the Green microdisplay is “viewed” at the output without reflection. The green skew ray quarter waveplate is oriented so that its principle axis is parallel to the axis of linearly polarized input light, and the green microdisplay is rotated so that its axis is also parallel to the axis of linearly polarized input light. Conversely, the skew ray quarter waveplates for the red and blue channels are oriented at 90 degrees, and their microdisplays are counter rotated compared to the green microdisplay orientation.

In an alternative, the orientation of the skew ray quarter waveplates are swapped such that the red and blue channel quarter waveplates are oriented parallel to the axis of linearly polarized input light and the green channel skew ray quarter waveplate is oriented at 90 degrees to the axis of linearly polarized input light. Therefore, as noted above, the preferred orientations of FIG. 10 include channels where the green channel shares a same number of reflections as a second channel, and, the green channel and second channel quarter waveplates are arranged with their principle axes parallel to the axis of linearly polarized input light.

In one embodiment, the present invention is utilized in a prism assebly in which the main optical components of the prism assembly (beam splitters) are liquid coupled. The beam splitters are set, for example, in prism assembly pathlength matched positions with joints between the beamsplitters. The joints are filled with liquid (e.g., an index matching fluid). A frame and/or a mounting plate in conjuction with an adhesive or other seal maintains the fluid within the prism assebly. Optical flats such as color selects (e.g., a product by ColorLink Corporation), dichroics, wavelength specific retarders, if needed for the prism assembly design, may also be inserted into the joints and immersed in the index matching fluid. The beam splitters may each comprise 2 prisms abutted on their diagonals and set in beamsplitter pathlength matched positions. A beam splitting layer is disposed on one or both of the diagonals. The beam splitting layer may be any of, for example, a polarizing beam splitting thin film (a PBS beamsplitter), a single color cholesteric layer, two cholestric layers of different colors (Cholesteric based Beam Splitters—CBSs), a dichroic layer, or any other material that can perform beam splitting.

Further practical matters relate to the waveplate materials themselves. Referring to the left hand side of FIG. 7 we see that the rotation of the microdisplay by θₒ requires that the width and height of the quarter waveplate increase to cover the entire area of the microdisplay. A better configuration for the waveplate is disclosed in the right hand side of FIG. 7. As shown, a principle axis of the quarter waveplate is still oriented vertically but the substrate has been cut into a rectangular shape that matches the dimensions of the rotated microdisplay. The advantage of this approach is that the size of the waveplate substrate remains that of the microdisplay. This configuration allows implementation of the microdisplay rotation without the added expense of a larger waveplate.

Another waveplate related issue is the choice of retarder material. Conventional waveplates are made from stretched plastic materials such as polycarbonate. An alternative is the use of a birefringent mineral such as quartz. A recently filed patent application entitled “Method and Apparatus for use and Construction of Higher Order Waveplates” discusses innovative means to use quartz in the construction of the required waveplates.

The second disclosed means of compensation is illustrated in FIG. 8. As shown, a principle optical axis of the quarter waveplate 820 is aligned parallel to the axis of the linearly polarized light output normal to the face of the PBS. Next in optical series is a half waveplate 840. A principle optical axis of the half waveplate 840 is oriented at an angle of ½θₒ with respect to a principle optical axis of the quarter waveplate. The effect of the half waveplate is to rotate the axis of the input linearly polarized light to an angle θₒ. Linearly polarized light with its axis oriented at θₒ is optimum input for residual retardation compensation in the microdisplay—without the need to rotate the microdisplay.

There is an assumption inherent to the description provided above regarding the use of the half waveplate. That is, that the residual retardation in the microdisplay is known and reproducible. This may or may not be true in current mass produced microdisplay products. With known and reproducible residual retardation, a retarder may be composed of a quarter waveplate bonded to a half waveplate with their principle optical axes aligned at an angle of ½θₒ with respect to each other. In this case the microdisplay would be mounted without mechanical rotation. Further, an integrated package may be constructed of a ¼ waveplate, a ½ waveplate, and a microdisplay all precisely mounted according to the orientations shown in FIG. 8. Without reliably reproduced residual retardation, then there are at least two configurational possibilities. A first is to use the bonded waveplates (½ waveplate and ¼ waveplate) just discussed but to rotate the microdisplay about its Z-axis to obtain the blackest possible dark state. A second is to maintain the microdisplay in the vertical orientation but to rotate the half waveplate about its Z-axis to obtain the blackest possible dark state.

Thus, in summary, several embodiments of the present invention are disclosed. In one example embodiment, the present invention provides a prism assembly comprising:
optical components arranged to manage first, second, and third light channels through a portion of the prism assembly and combine the first, second, and third channels prior to exiting an output face of the prism assembly;
a first quarter waveplate placed in the first light channel and oriented such that a principle axis of the first quarter waveplate is aligned parallel to the axis of linearly polarized light input to the first quarter waveplate;
a second quarter waveplate placed in the second light channel and oriented such that a principle axis of the second quarter waveplate is aligned parallel to the axis of linearly polarized light input to the second quarter waveplate;
a third quarter waveplate placed in the third light channel and oriented such that a principle axis of the third quarter waveplate is aligned perpendicular to the axis of linearly polarized light input to the third quarter waveplate.

The prism assembly may then be fitted with microdisplays to become a kernel, this example embodiment further comprising:
a first microdisplay located in the first light channel in an orientation that aligns an optical axis of the first microdisplay with the axis of linearly polarized light input to the first microdisplay;
a second microdisplay located in the second light channel in an orientation that aligns an optical axis of the second microdisplay with the axis of linearly polarized light input to the second microdisplay; and
a third microdisplay located in the third light channel in an orientation that aligns an optical axis of the third microdisplay with the axis of linearly polarized light input to the third quarter waveplate.

The example embodiment may include, for example, wherein one of the 1st and 2nd microdisplays is a microdisplay to be activated with a green content portion of video and image data, and/or wherein one of the 1st and 2nd channels is a green light channel.

In yet another example embodiment, a prism assembly is provided, comprising:
3 light channels;
2 parallel waveplates and 1 perpendicular waveplate, each individually positioned in a respective one of the 3 light channels;
the parallel waveplates oriented so as to have a principle axis oriented parallel to an axis of linearly polarized light input to the parallel waveplates and the perpendicular waveplate is oriented with its principle axis perpendicular to an axis of linearly polarized light input to the perpendicular waveplate; and
3 microdisplays are attached to the prism assembly, each individually positioned in a respective one of the light channels and an axis of each microdisplay is parallel to an axis of polarized light input to the quarter waveplate of the same channel. In yet further embodiments, a ½ waveplate is introduced to effectively rotate an axis of linear polarization of input light to match an optical axis of a corresponding microdisplay.

This application incorporates by reference, in its entirety, U.S. patent application to Berman, entitled “METHOD AND APPARATUS FOR INCREASING MICRODISPLAY BLACK STATE IN LIGHT MANAGEMENT SYSTEMS AND FLEXIBILITY TO UTILIZE POLARIZED OR UNPOLARIZED INPUT LIGHT,” Ser. No. 10/382,766, atty. docket no. 356508.01001, filed May 5, 2003.

Although the present invention has been described herein with reference to PBS and quad style prismn assemblies, the devices and processes of the present invention may be applied to other prism assembly designs and components thereof (CBSs or other beamsplitter, L or X prisms, etc.).

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. Furthermore, the inventors recognize that newly developed technologies not now known may also be substituted for the described parts and still not depart from the scope of the present invention.

The present invention may suitably comprise, consist of, or consist essentially of, any of element (the various parts or features of the invention) and their equivalents. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

1. A method of skew ray and residual retardation compensation in a microdisplay based device, comprising the steps of:
operating on light channel directed to a microdisplay with a quater waveplate oriented such that a principle axis of the quater waveplate is aligned parallel to an axis of linear polarization of the light channel incident upon the quarter waveplate;
modulating the light channel after the quarter waveplate with a microdisplay oriented at an angle θₒ such that an optical “axis” of the microdisplay is optimally oriented for residual retardation compensation with respect to the linearly polarized light input to the microdisplay from the quarter waveplate.

2. A prism assembly, comprising:
a set of optics configured to break an input light beam into at least a first component light beam and a second component color light beam;
a first quarter wavplate inserted in the first component light beam and oriented such a principle axis of the first quater waveplate is aligned parallel to an axis of linear polarization of the first component light beam; and
a second quarter wavplate inserted in the second component light beam and oriented such a principle axis of the second quater waveplate is aligned perpendicular to an axis of linear polarization of the second component light beam.

3. The prism assembly according to claim 2, wherein:
the set of optics is further configured to break the input light beam further into at least a third component color light beam; and
the prisn assembly further comprising a third quarter wavplate inserted in the second component light beam and oriented such a principle axis of the second quater waveplate is aligned parallel to an axis of linear polarization of the second component light beam.

4. The prism assembly according to claim 3, further comprising:
a set of modulation devices each respectiviely inserted into a corresponding one of the component color light beams and each modulation device configured to modulate its respective corresponding component light beam;
wherein the color compnonent light beams having parallel quarter waveplates are reflected N times ater modulation and the color component light beams having perpendicular quarter waveplates are reflected M times after modulation.

5. The prism assembly according to claim 3, further comprising:
a set of modulation devices each respectiviely inserted into a corresponding one of the component color light beams and each modulation device configured to modulate its respective corresponding component light beam;
wherein the color compnonent light beams having parallel quarter waveplates are reflected ater modulation and the color component light beams having perpendicular quarter waveplates are not reflected after modulation.

6. The prism assembly according to claim 3, further comprising:
a set of modulation devices each respectiviely inserted into a corresponding one of the component color light beams and each modulation device configured to modulate its respective corresponding component light beam;
wherein the color compnonent light beams having perpendicular quarter waveplates are reflected after modulation and the color component light beams having parallel quarter waveplates are reflected after modulation.

7. A microdisplay package, comprising:
a quater waveplate oriented such that a principle axis of the quater waveplate is aligned parallel to reference axis; and
a microdisplay device coupled to the quarter waveplate and oriented at an angle θₒ such that an optical “axis” of the microdisplay is optimally oriented for residual retardation compensation with respect to the linearly polarized light input to the microdisplay from the quarter waveplate when the reference axis is parallel to an axis of linear polarization of light incident to the quarter waveplate.

8. The microdisplay package according to claim 7, wherein the quarter waveplate is cut such that outer dimensions of the quarter waveplate cover an optical face of the microdisplay.

9. The microdisplay package according to claim 7, wherein the quarter waveplate is cut such that outer dimensions of the quarter waveplate are congruent with an optical face of the microdisplay.

10. The microdisplay package according to claim 7, wherein the quarter waveplate is cut such that outer dimensions of the quarter waveplate is proportaional to dimensions of an optical face of the microdisplay.

11. The microdisplay package according to claim 7, wherein the quarter waveplates are constructed from higher order waveplates.

12. A microdisplay package, comprising:
a microdisplay having an optical axis;
a quarter waveplate coupled to the microdisplay.

13. The microdisplay package according to claim 12, wherein the quarter waveplate is cut such that a principle axis of the quarter waveplate is parallel to the optical axis of the microdisplay.

14. A microdisplay package, comprising:
A quater waveplate having a principle axis parallel of a reference axis;
a half waveplate having a principle optical axis oriented at an angle of (½)θₒ with respect to the reference axis; and
a microdisplay having an optical axis oriented at an angle of θₒ with respect to the reference axis.

15. The microdiplay package according to claim 14, wherein a mechanical axis of the microdisplay is at an angle of θₒ with respect to the microdisplay optical axis.

16. The microdisplay package according to claim 14, wherein a mechanical axis of the half waveplate and a mechanical axis of the microdisplay are parallel.

17. The microdisplay package according to claim 14, wherein a mechanical axis of the quarter waveplate and a mechanical axis of the half waveplate, and a mechanical axis of the microdisplay are all parallel.

18. The microdisplay according to claim 17, wherein the mechanical axis of the quarter waveplate is parallel to the reference axis.

19. The microdisplay package according to claim 14, wherein a mechanical axis of the quarter waveplate is parallel to the reference axis.

20. The microdisplay package according to claim 14, wherein a mechanical axis of the quarter waveplate and a mechanical axis of the half waveplate, and a mechanical axis of the microdisplay are all parallel.

21. The microdisplay package according to claim 14, wherein the half waveplate is cut such that a principle optical axis of the half waveplate is oriented at an angle of ( 1/2)θₒ with respect a mechanical axis of the half waveplate.

22. The microdisplay package according to claim 21, wherein a mechanical axis of the half waveplate comprises a centerline of the half waveplate.

23. The microdisplay package according to claim 14, wherein at least one of the quarter waveplate and the half waveplate are compensated higher order waveplates.

24. The microdisplay package according to claim 15, wherein at least one of the quarter waveplate and the half waveplate are compensated higher order waveplates.

25. The microdisplay package according to claim 15, wherein the microdisplay package is mounted on a quad style liquid coupled kernel having at least 3 light channels.

26. A prism assembly comprising:
a set of optics configured to break an input light beam into component color light beams, direct each component color light beam to a corresponding modulation device for modulation, and recombine the modulated component light beams into an output beam containing an image according to an enerigation of the modulation devices; and
at least one a quater waveplate inserted in at least one of the component color light beams and oriented such that a principle axis of the at least one quater waveplate is aligned parallel to an axis of linear polarization of the component color light beam incident thereto;
wherein the modulation device corresponding to the at least one component color light beam is oriented at an angle θₒ such that an optical “axis” of the microdisplay is optimally oriented for residual retardation compensation with respect to the linearly polarized light input to the microdisplay from the quarter waveplate.

27. A prism assembly, comprising:
optical components arranged to manage first, second, and third light channels through a portion of the prism assembly and combine the first, second, and third channels prior to exiting an output face of the prism assembly;
a first quarter waveplate placed in the first light channel and oriented such that a principle axis of the first quarter waveplate is aligned parallel to the axis of linearly polarized light input to the first quarter waveplate;
a second quarter waveplate placed in the second light channel and oriented such that a principle axis of the second quarter waveplate is aligned parallel to the axis of linearly polarized light input to the second quarter waveplate; and
a third quarter waveplate placed in the third light channel and oriented such that a principle axis of the third quarter waveplate is aligned perpendicular to the axis of linearly polarized light input to the third quarter waveplate.

28. The prism assembly according to claim 27, further comprising a set of microdisplays, each microdisplay oriented relative to a corresponding to one of the quarter waveplates.

29. The prism assembly according to claim 27, further comprising:
a first microdisplay located in the first light channel in an orientation that aligns an optical axis of the first microdisplay with the axis of linearly polarized light input to the first microdisplay;
a second microdisplay located in the second light channel in an orientation that aligns an optical axis of the second microdisplay with the axis of linearly polarized light input to the second microdisplay; and
a third microdisplay located in the third light channel in an orientation that aligns an optical axis of the third microdisplay with the axis of linearly polarized light input to the third quarter waveplate.

30. The prism assembly according to claim 28, wherein one of the 1st and 2nd microdisplays is a microdisplay to be activated with a green content portion of video image data, and the microdisplay activated with the green content portion of the video image data is in the green light channel.

31. A prism assembly, comprising:
at least 3 light channels;
a set of parallel waveplates and at least one perpendicular waveplate, each parallel and perpendicular waveplate individually positioned in a respective one of the light channels;
the parallel waveplates oriented so as to have a principle axis oriented parallel to an axis of linearly polarized light input to the parallel waveplates and the perpendicular waveplate is oriented with its principle axis perpendicular to an axis of linearly polarized light input to the perpendicular waveplate; and
at least 3 microdisplays attached to the prism assembly, each individually positioned in a respective one of the light channels and an axis of each microdisplay is parallel to an axis of polarized light input to the quarter waveplate of the same channel.

32. The prism asssembly according to claim 31, further comprising a ½ waveplate positioned in a light path of at least one of the microdisplays and oriented so as to rotate an axis of linear polarization of the light path to match an optical axis of a corresponding microdisplay.

33. A method, comprising the steps of:
placing a quarter waveplate and a half waveplate together such that a principle optical axis of the quarter waveplate is oriented at ½)θₒ with respect to a principle optical axis of the half waveplate;
applying an linearly polarized light to one side of the bonded waveplates;
rotating an LCoS micordisplay at an opposite side of the bonded waveplates until a blackest possible dark state is obtained; and
securing the rotated position of the LCoS microdisplay.

34. The method according to claim 33, wherein the linearly polarized light is applied such that an axis of linear polarization of the light is parallel to the principle optical axis of the quarter waveplate.

35. The method according to claim 33, wherein the linearly polarized light is applied to the waveplates through a prism assembly.

36. The method according to claim 35, wherein the dark state is observed at an output of the prism assembly.

37. A method, comprising the steps of:
alighning a quarter waveplate, a half waveplate, and a microdsiplay in optical series;
applying linearly polarized light such that an axis of polarization of the linearly polarized light is parallel to a principle optical axis of the quarter waveplate;
observing a black state of the microdisplay; and
adjusting positions of the halfwaveplate until a blackest possible black state is obtained.

38. The method according to claim 37, whherein said step of adjusting comprises adjusting positions of the halfwaveplate the microdisplay until a blackest possible black state is obtained.
